(19) United States
(12) Patent Application Publication
(10) Pub. No.: US 2012/0103929 A1
(43) Pub. Date: May 3, 2012

(54) PLASTIC BOTTLE

(75) Inventor: Caroline Fontana, Puteaux (FR)

(73) Assignee: COLGATE-PALMOLIVE COMPANY, New York, NY (US)

(21) Appl. No.: 13/382,062

(22) PCT Filed: Jul. 12, 2010
(86) PCT No.: PCT/US2010/041646

§ 371 Date: Jan. 3, 2012

Related U.S. Application Data
(60) Provisional application No. 61/224,564, filed on Jul. 10, 2009.

(51) Int. Cl. B65D 90/02; B29C 65/20

(52) U.S. Cl. 215/382; 264/249

(57) ABSTRACT

A light weight flat container such as a bottle (20) formed of an elastically deformable plastic material and having a staged load bearing system including primary and secondary load bearing surfaces. The bottle includes two op posing wide sides (21, 22) and two opposing narrow sides (25, 26) on which the load bearing surfaces may be disposed. A base (27) is provided which protrudes beyond the narrow sides (25, 26) in some embodiments. During processing of the bottles on a conveyor fill line, mating primary load bearing surfaces (30, 30′) on adjacent bottles initially engage and begin to deform under contact forces. The mating secondary load bearing surfaces (32, 32′) next engage to better distribute the contact forces and control deformation of the bottles to below the elastic limit of the plastic material to avoid plastic deformation or crazing damage to the bottles when the contact forces subsides. A bottle processing method is also provided.

### CROSS-REFERENCE TO RELATED PATENT APPLICATIONS

The present application claims the benefit of U.S. Provisional Patent Application No. 61/224,564, filed Jul. 10, 2009, the entirety of which is hereby incorporated by reference.

### BACKGROUND

The present invention relates generally to containers, and more particularly to low or light weight plastic bottles.

There is an increasing challenge for producing low or light weight plastic bottles for use such as in liquid packaging. This is driven by cost and sustainability. This demand is being fulfilled for cylindrical or square bottles, such as those used for bottled water or other beverages and other products. Nevertheless, there remains a need for light weight flat bottles, such as without limitation those used in product categories including home care products, personal care packaging, and others. Flat bottles are those for which the foot print or base shows a significant minor axis—major axis difference, typically higher than a 2 to 1 ratio and in any case generally at least higher than a 1.5 to 1 ratio. Flat bottles were conceived to optimize shelf impression, label size, etc. so there is a continuing marketing demand for such shaped containers.

This trend towards light weight flat bottles is reinforcing the need to use low weight materials such as polyethylene terephthalate (PET or PETE) instead of other commonly used bottle materials such as polyolefins (e.g. polyethylene or polypropylene). It is generally recognized that everything being similar (e.g. container size), PET allows a reduction in bottle weight in comparison to these polyolefins. For instance, high density polyethylene (HDPE) is commonly used for product packaging such as milk jugs, laundry detergent containers, etc. As an example, a 1 L PET bottle in a container size of about 120-130 mm width, 232 mm height (without neck), and 56 mm depth (typical container size for Europe) will be in the 40-50 gram range instead of 56-65 gram range for HDPE.

In the case of flat bottles, this lightening of the weight leads to very thin wall thicknesses, typically less than about 0.3 mm, and in some cases even down to about 0.15 mm minimum, in the narrow small vertical sides of the bottle located at each terminal end of the major axis (front to back) of the bottle foot print. All the more, PET is more rigid than polyolefins, leading more easily to permanent deformation, or deformation with resilience but leaving visible white traces or lines on the material (so-called crazing effect) which is not aesthetically pleasing to consumers.

In parallel with the trend toward light weight bottles, it is known that the industry trend is to concurrently develop and implement high speed product processing and container fill lines, with output speeds over 150 bottles per minute (bpm), and even up to 300 or more bpm.

Therefore, with these foregoing technology evolutions, having low weight PET flat bottles on a high speed product line leads to new issues with bottle impact resistance and handling on process line conveyors. Bottles running on automated process lines come into abrupt contact with each other on their two opposite small depth vertical sides (i.e. generally parallel to the minor axis). If these contact points or surfaces between bottles are too small in area based on the material wall thickness used, then there may be permanent denting or at least the bottles become marked by white crazing lines at the deformation locations. Either of these two effects are not acceptable in the scope of usual production quality.

Accordingly, an improved bottle design is desirable for light weight materials such as PET or similar plastics.

### BRIEF SUMMARY

A light weight, thin-walled plastic flat container such as a bottle with improved impact resistance is provided that is configured and adapted to reduce or eliminate damage resulting from handling on high speed product processing lines. In one embodiment, a bottle according to the present invention includes first and second primary contact regions or bearing surfaces disposed on opposite narrow (i.e. small or short depth) sides of the bottle. In some embodiments, the bottle further preferably includes third and fourth secondary contact regions or bearing surfaces disposed on the same opposite narrow sides of the bottle. Preferably, the primary bearing surfaces are spaced apart from and located at a different elevation on the narrow sides of the bottle than the secondary contact surfaces. Both the primary and second bearing surfaces are each preferably located respectively at the same elevation on the bottles.

The present invention provides a two-stage load bearing system which includes primary and secondary load bearing surfaces. With this system, when contact happens between adjacent bottles at a liquid filling station or elsewhere on a process line, the bottles are first slightly bent or deformed at the primary bearing surfaces. Then, the secondary bearing surfaces come into mutual contact having a large enough mating surface area to control or limit deformation and avoid further substantial bending at the primary bearing surfaces which might otherwise cause permanent denting or crazing. Then, when contact stops, the bottles elastically return to their original shape with no permanent dents or crazing. Advantageously, embodiments of the present invention preferably minimize deformation of the material to the elastic range and avoid plastic deformation. The allowable elastic deformation is further minimized to the range wherein crazing lines are preferably avoided or at least minimized.

In one embodiment, the present bottle is made of a rigid, light weight yet elastic plastic. In a preferred embodiment, the bottle is made of PET.

According to one embodiment of the present invention, a flat thin-walled plastic bottle with staged load bearing system includes a base and preferably integral sidewalls formed of an elastically deformable plastic material and defining a central vertical axis. The sidewalls include two opposing wide sides defining a minor axis and depth therebetween and two opposing narrow sides defining a major axis and width therebetween that is greater than the depth. In some embodiments, the major to minor axis ratio may be 1.5:1 or larger. The base may be horizontally enlarged in relation to the sidewalls and protrudes outwards beyond at least one narrow side of the bottle. Based on the shape and thickness of the sidewalls and elastic limit of the plastic material selected, the base is designed in configuration and structure to have a predetermined maximum allowable inward deflection ε towards the central axis wherein an inward deformation of the base exceeding the maximum allowable deflection ε results in plastic deformation or crazing of the base. The bottle further includes a first primary load bearing surface disposed on the base on the at least one narrow side and located at a first distance from the central axis, and a first secondary load bearing surface disposed on the at least one narrow side above the primary load bearing surface and located at a second distance from the central axis that is less than the first distance by an amount substantially equal to the maximum allowable deflection ε. Deformation of the primary load bearing surface on the base towards the central axis is limited by the first secondary load bearing surface on the at least one narrow side to the maximum allowable deflection ε when an inward contact force is applied by an object that engages the first primary and second load bearing surfaces. In some embodiments, the object is a second bottle.

According to another embodiment of the present invention, a thin-walled flat plastic bottle with staged load bearing system includes a top, a bottom, and sidewalls extending between the top and bottom. The sidewalls included a wide front side and an opposing wide rear side defining a minor axis and depth therebetween, and a narrow forward facing side and an opposing narrow rearward facing side defining a major axis and width therebetween larger than the depth. The bottle further includes a base integral with the sidewalls and formed of an elastically deformable plastic material with the sidewalls. The base and sidewalls define a central vertical axis of the bottle. The base may be horizontally enlarged in relation to the sidewalls and protrudes horizontally outwards beyond each of the two narrow sides in a forward and rearward direction. The base is configured and structured to have a predetermined maximum allowable inward deflection ε towards the central axis on the forward facing narrow side and a predetermined maximum allowable inward deflection towards the central axis on the rearward facing narrow side, wherein an inward deformation of the base exceeding the maximum allowable deflection ε or \acute{ε} results in plastic deformation or crazing of the base. A first primary load bearing surface may be disposed on the base on the forward facing narrow side and located at a first distance from the central axis. A first secondary load bearing surface may be disposed on the forward facing narrow side and spaced vertically apart from the first primary load bearing surface on the base; the first secondary load bearing surface being located at a second distance from the central axis that is less than the first distance by an amount substantially equal to the maximum allowable deflection ε of the base on the forward facing narrow side. The bottle further includes a second primary load bearing surface disposed on the base on the rearward facing narrow side and located at a third distance from the central axis, and a second secondary load bearing surface disposed on the rearward facing narrow side and spaced vertically apart from the second primary load bearing surface on the base; the second secondary load bearing surface being located at a fourth distance from the central axis that is less than the third distance by an amount substantially equal to the maximum allowable deflection \acute{ε} of the base on the rearward facing narrow side. The bottle is operable such that deformation of the first primary load bearing surface on the base towards the central axis is limited by the first secondary load bearing surface on the forward facing narrow side to the maximum allowable deflection ε when an inward contact force is applied by an object that engages the first primary and secondary load bearing surfaces. The bottle is further operable such that deformation of the second primary load bearing surface on the base towards the central axis is limited by the second secondary load bearing surface on the rearward facing narrow side to the maximum allowable deflection \acute{ε} when an inward contact force is applied by an object that engages the second primary and secondary load bearing surfaces.

A method of processing thin-walled flat plastic bottles is also provided. In one embodiment, the method may include the steps of: providing a first and a second thin-walled flat bottle each comprising a base and integral sidewalls formed of an elastically deformable plastic material and defining a central vertical axis, the sidewalls including two opposing wide sides, a forward facing narrow side extending between the wide sides, and an opposing rearward facing narrow side extending between the wide sides, at a least portion of the base of each bottle further being configured to protrude forward beyond the forward facing narrow side of each respective bottle by a first distance; moving the first and second bottles together on a process line conveyor; initially engaging the forward protruding base portion of the first bottle with a rearward protruding base portion of the second bottle; applying an inward contact force on the forward protruding base portion of the first bottle with the rearward protruding base portion of the second bottle; deflecting the forward protruding base portion of the first bottle inwards towards the central axis of the first bottle by the first distance; simultaneously engaging the forward protruding base portion of the first bottle and a load bearing surface on a portion of the forward facing narrow side of the first bottle spaced above the base with the rearward protruding base portion of the second bottle; and removing the inward contact force on the forward protruding base portion of the first bottle from the rearward protruding base portion of the second bottle, wherein the forward protruding portion returns to an original configuration before the deflecting step.

In still a further embodiment, the invention may be a plastic bottle with staged load bearing system comprising: sidewalls formed of an elastically deformable plastic material and defining a central vertical axis, the sidewalls including opposing sides; the opposing sides configured and structured to have a predetermined maximum allowable inward deflection ε towards the central axis wherein an inward deformation of the opposing sides exceeding the predetermined maximum allowable deflection ε results in plastic deformation or crazing of the opposing sides; a first primary load bearing surface disposed on a first of the opposing sides and located at a first distance from the central axis; and a first secondary load bearing surface disposed on the first of the opposing sides either above or below the primary load bearing surface and located at a second distance from the central axis that is less than the first distance by an amount substantially equal to the maximum allowable deflection ε.

The foregoing and other aspects of a bottle formed according to principles of the present invention are further described herein.

### BRIEF DESCRIPTION OF THE DRAWINGS

The features, and advantages of the invention will be apparent from the following more detailed description of certain embodiments of the invention and as illustrated in the accompanying drawings in which:

FIGS. 1 and 2 are schematic perspective forward and rearward views of a bottle, according to one or more embodiments of the invention;

FIGS. 3 and 4 are side views of the bottle of FIGS. 1 and 2:

FIG. 5 is a rearward side view of the bottle of FIGS. 1 and 2;

FIG. 6 is a forward side view of the bottle of FIGS. 1 and 2;

FIG. 7 is a top view of the bottle of FIGS. 1 and 2;

FIG. 8 is a bottom view of the bottle of FIGS. 1 and 2;

FIG. 9 is a side view of two bottles according to FIGS. 1 and 2 during initial contact with each other such as on a product processing and fill line;

FIG. 10 is a side view of the two bottles according to FIG. 9 during subsequent further and more forceful contact with each other; and

FIG. 11 is a cross section taken along line 11-11 in FIG. 3 at the location of primary contact or load bearing surfaces.

### DETAILED DESCRIPTION

This description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” and “interconnected” refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features; the scope of the invention being defined by the claims appended hereto.

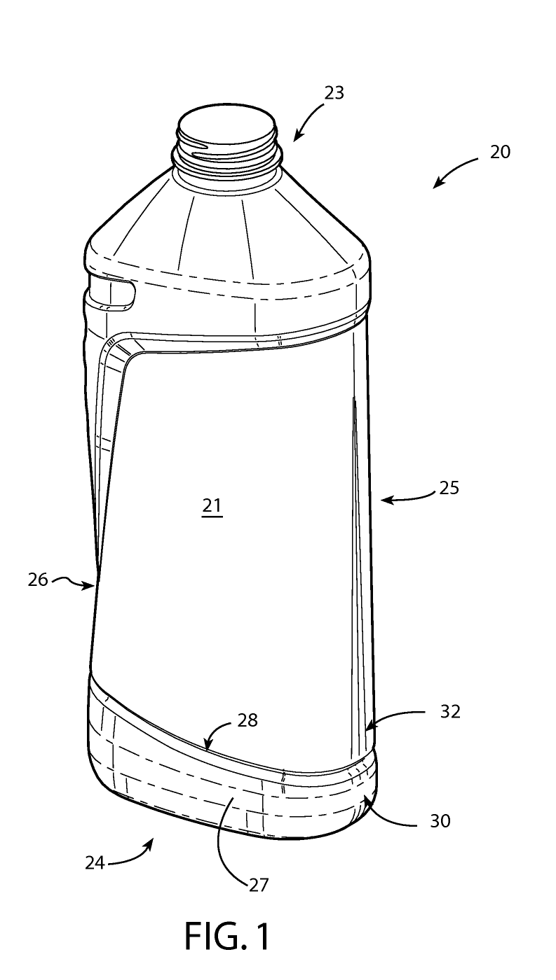

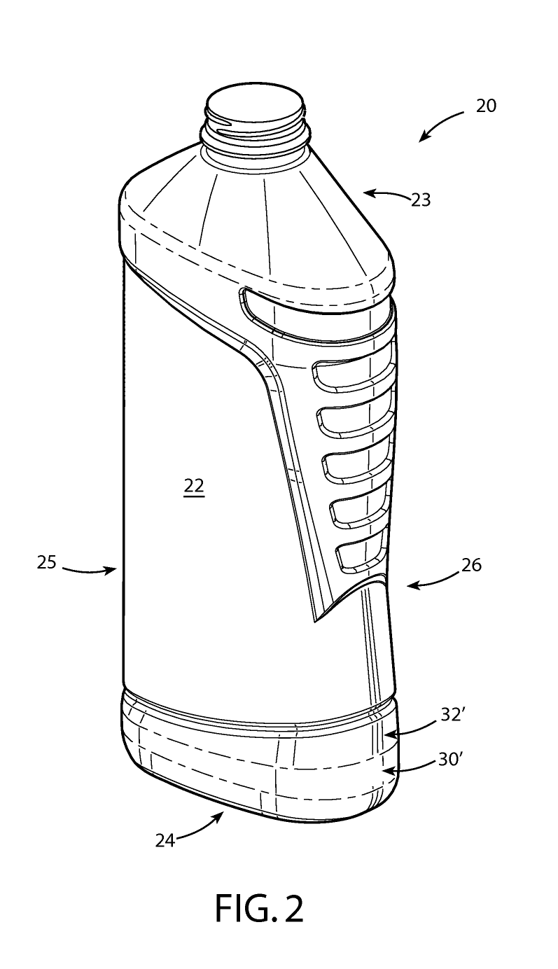

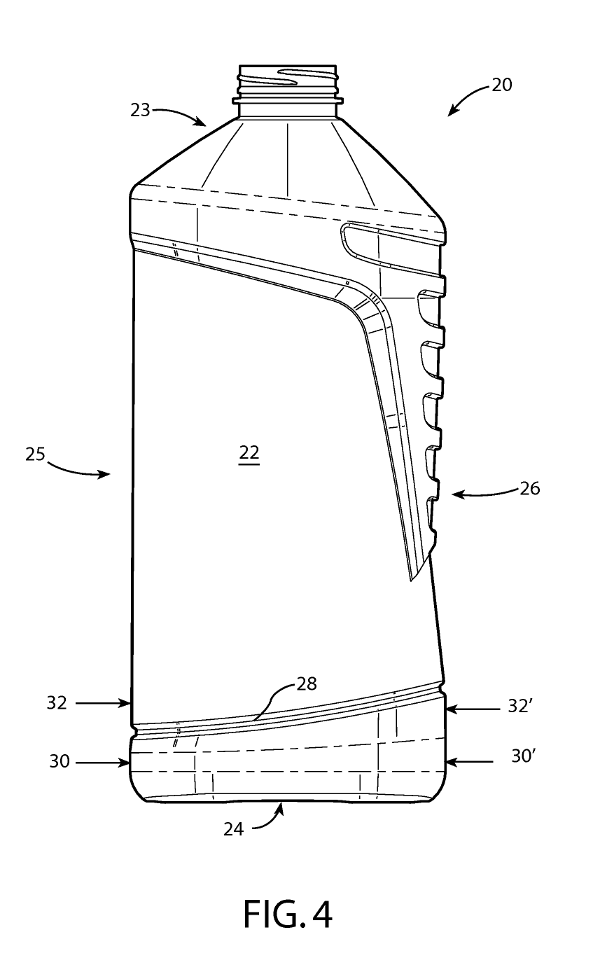

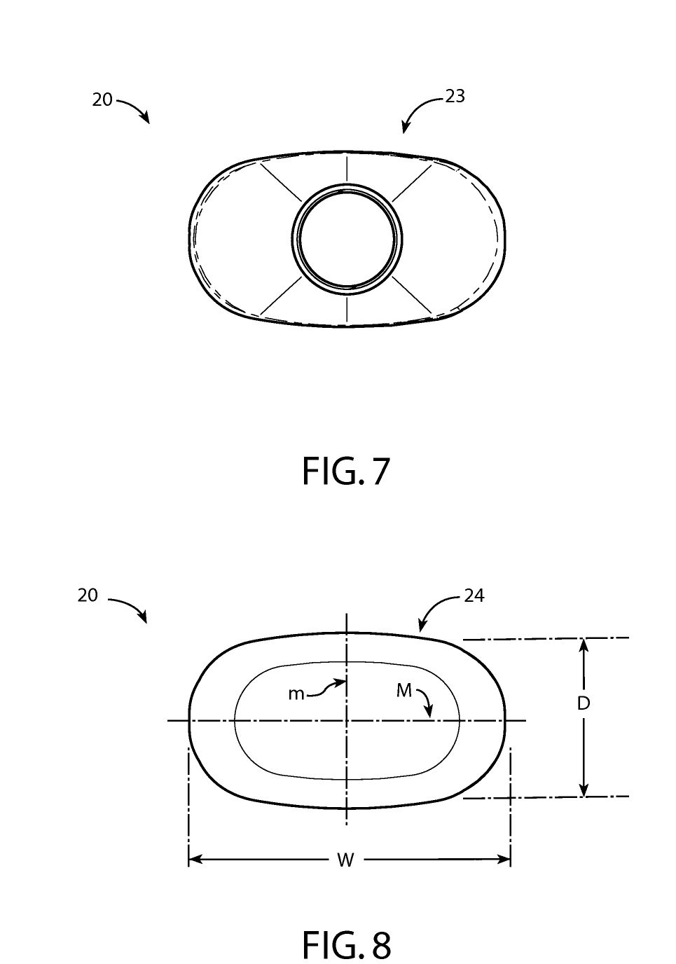

FIGS. 1-8 illustrate one possible embodiment of a light weight, thin-walled flat container, such as a bottle. Preferably, the bottle is made of a rigid plastic material such as without limitation PET, polystyrene (PS), polycarbonate, or others. In a preferred embodiment, the bottle is made of PET. However, in alternative embodiments, it will be appreciated that a bottle formed according to principles of the present invention may be made of any suitable commercially-available plastic

Referring to FIGS. 1-8, a bottle 20 includes sidewalls including a first wide front side 21, a second wide rear side 22, a narrow forward facing side 25, a narrow rearward facing side 26, a top 23 including a shoulder portion and neck or spout, and a bottom 24. The “forward” and “rearward” designations refer to an arbitrary reference system of the orientation and direction of the bottles 20 as they proceed down an automated processing line for ease in describing the functional aspects of the bottle disclosed herein.

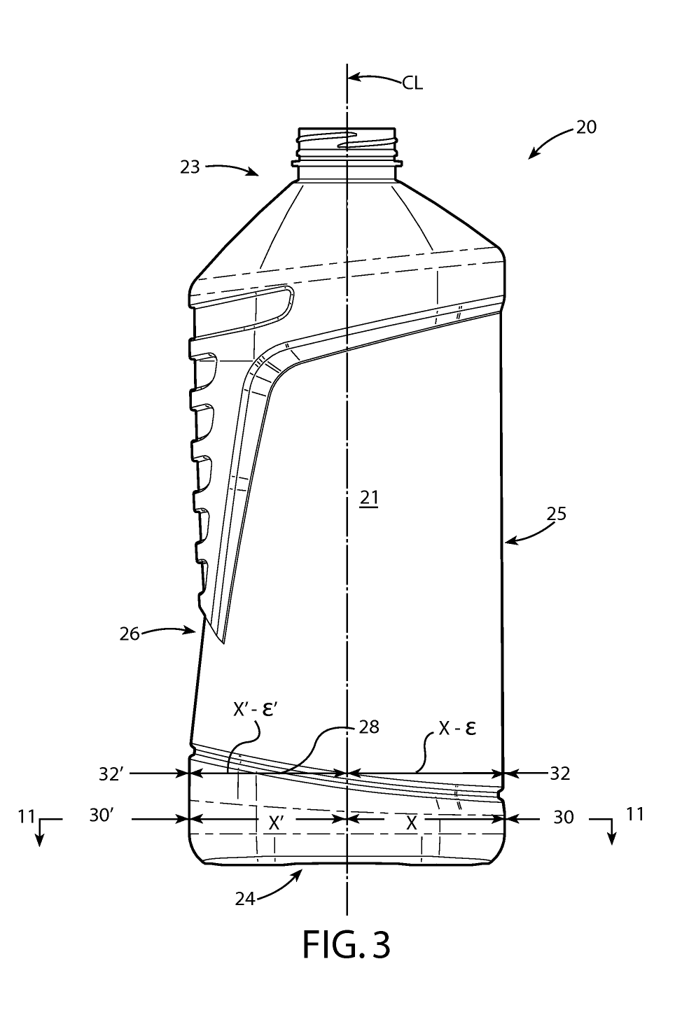

Bottle 20 defines an axial centerline CL (see FIG. 3) extending vertically through the bottle. In one embodiment, the lower portion of bottle 20 includes a base 27 which may include a demarcation feature such as a circumferential groove 28 or otherwise that defines the base. In some embodiments, base 27 may have a different configuration, cross-sectional shape, and/or size than other portions of bottle 20. In some embodiments, base 27 may be slightly enlarged in contrast to adjoining portions of bottle 20 to provide added stability to the bottle when placed on a horizontal surface. In other embodiments, base 27 may be the same size and configuration as other portions of bottle 20 or bottle 27 may not have a distinct base feature.

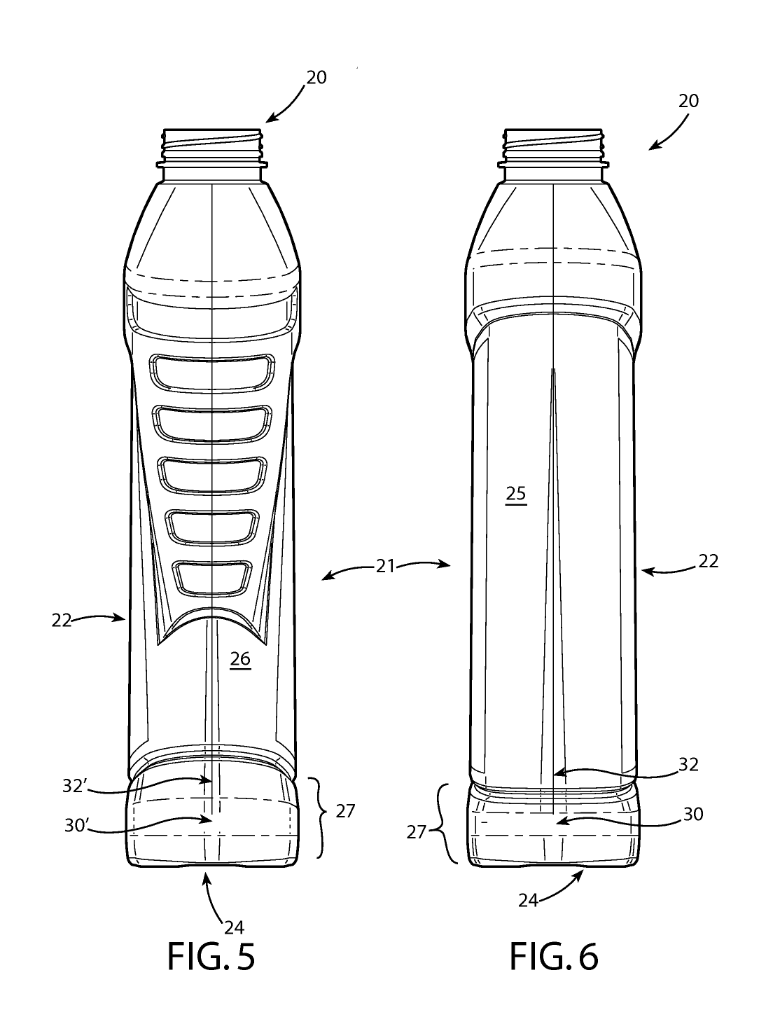

With particular reference now to FIGS. 5-8, the preferred flat type bottle configuration of bottle 20 is best shown. Bottle 20 defines a major axis “M” and a minor axis “m” (see FIG. 8). As shown, bottle 20 further defines a depth “D” measured along the minor axis m between the front and rear wide sides 21, 22 of the bottle, and a width “W” measured along the major axis M between the forward and rearward narrow sides 25, 26. In a preferred embodiment, bottle 20 is a “flat” type bottle having a foot print or horizontal cross-section therefore with a substantial major axis to minor axis (i.e. depth D to width W) difference or ratio M:m preferably equal to or larger than about a 1.5:1 ratio of the major axis to minor axis, and more preferably larger than about 2:1.

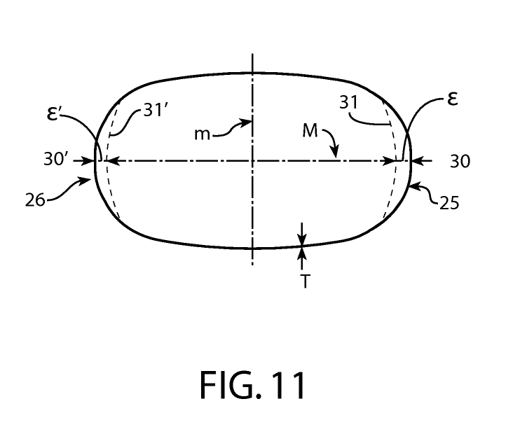

In some preferred embodiments, bottle 20 may have a nominal wall thickness T (see FIG. 11) in the range from about and including 0.15 mm to about and including 0.3 mm. Preferably, bottle 20 is made of a rigid, yet elastically deformable polymer or plastic material such as PET or material with similar physical properties and characteristics. Plastic materials usable in the present invention have various mechanical properties including an elastic limit, which is the highest stress that can be applied to an elastic body without creating permanent or plastic deformation. Forces and stresses applied to the elastic material or body within the elastic range preceding but not exceeding the elastic limit will generally cause temporary deformation of the body, but without inducing a permanent set or plastic deformation. The elastic material or body will return to its original shape and configuration after the deforming stress or forces are removed provided they do not exceed the elastic limit. These fundamental material concepts and behaviors are well known and understood by those skilled in the art and do not merit further explanation.

With continuing reference to FIGS. 1-8, in one embodiment, bottle 20 includes first and second primary bearing surfaces 30, 30′ disposed on opposite narrow forward and rearward sides 26, 25 of the bottle. In preferred embodiments, the bottle further may include third and fourth secondary bearing surfaces 32, 32′ disposed on the same opposite narrow sides of the bottle. Preferably, the primary bearing surfaces 30, 30′ are spaced apart from and located at a different elevation on the narrow sides of the bottle than the secondary bearing surfaces 32, 32′. Primary bearing surfaces 30 and 30′ are preferably disposed at the same elevation or vertical position on bottle 20 so that these surfaces on two different bottles when placed in an abutting relationship will be mutually aligned with each other. Secondary bearing surfaces 32 and 32′ are preferably also disposed at the same elevation or vertical position on bottle 20 for the same reason.

In one exemplary embodiment as shown in FIG. 3, base 27 may have a vertical height on rearward narrow side 26 of bottle 20 that is greater than the vertical height of base 27 disposed on forward narrow side 25. In this embodiment, secondary bearing surface 32′ may be disposed on the taller rear portion of base 27 as shown. In other possible alternative embodiments contemplated, base 27 may have a relatively uniform height from forward narrow side 25 to rearward narrow side 26 such that circumferential groove 28 is substantially horizontal instead of angled as shown in the figures. In this alternative embodiment, secondary bearing surface 32′ may be disposed on rearward narrow side 26 above base 27 in lieu of being formed on the base itself so long as it is horizontally aligned with corresponding secondary bearing surface 32.

With particular reference to FIG. 3, primary bearing surfaces 30 and 30′ are each located at a distance X and X′ respectively from axial centerline CL. Secondary bearing surfaces 32 and 32′ are each located at a distance X−ε (i.e. X minus ε) and X−\acute{ε}´ respectively from axial centerline CL, where ε and \acute{ε} are engineering symbols representing deformation or strain that the material undergoes when load is applied. In this case, ε and \acute{ε} are the maximum allowable material deflection or deformation values (in units of length such as mm) for bottle 20 measured along the major axis M that the primary bearing surfaces 30 and 30′ will be physically permitted to deform or bend inwards (i.e. maximum deflection distance) when two bottles 20 are forced into each other on a process conveyer (see also FIG. 11). These maximum deformation values ε and \acute{ε} are pre-selected at the point prior to plastic deformation of the material (i.e. based on the elastic limit of the material selected) causing permanent unrecoverable deformation or denting, or excessive elastic deformation which leaves residual white crazing lines after the deforming forces or stresses are removed from the bottle.

Based on the foregoing, base 27 of bottle 20 in the region of bearing surfaces 30, 30′ therefore preferably protrudes slightly outwards farther in both the forward and rearward directions along the major axis M than bearing surfaces 32, 32′ by a maximum distance equal to ε and \acute{ε} respectively. In one exemplary preferred embodiment, the sum or total of the allowable or permissible deformation ε+\acute{ε} is equal to or less than about 3 mm in distance when PET is used for bottle 20 to prevent permanent damage to the bottle such as plastic deformation or dents which will not return to their original configuration when the load or force between the bottles is removed or white line crazing.

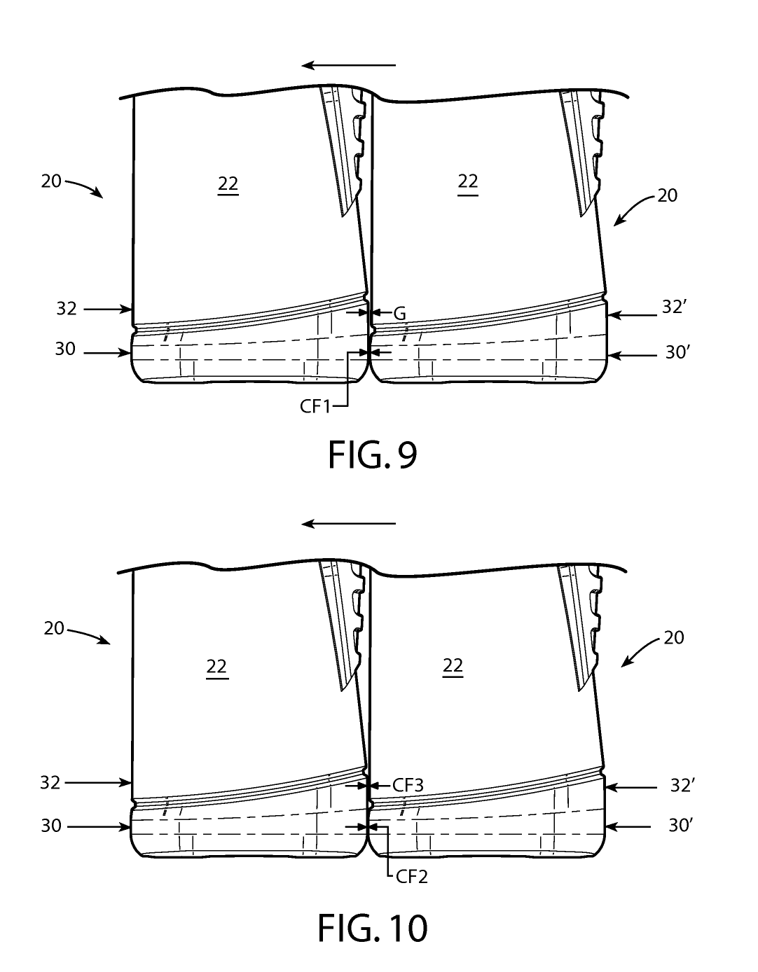

The operation of the two-stage load bearing system provided by the present invention will now be described with reference to FIGS. 1-8, and particularly FIGS. 9-11. FIG. 11 is a horizontal cross-section taken through bottle 20 at the elevation of primary bearing surfaces 30 and 30′ as shown in FIG. 3.

When a plurality of bottles are processed on a high speed processing and fill line conveyor such as illustrated in FIGS. 9 and 11 (arrows showing direction of conveyor motion), the rearward facing narrow side 26 of a first bottle 20 typically contacts the forward facing narrow side 25 of a second bottle 20 positioned directly behind the first bottle on the conveyor. This contact may typically occur at the filling station on the process line where the bottle being filled with a liquid may be temporarily slowed or stopped allowing the bottle directly behind to come into contact. An initial “touching” contact occurs between the first and second primary bearing surfaces 30, 30′ of the first and second bottles 20 (see FIG. 9). The initial contact force CF1 between the bottles 20 is such that there is no significant or minimal measurable elastic deformation or bending of either bottle that occurs at surfaces 30, 30′. In a preferred embodiment, the third and fourth secondary bearing surfaces 32, 32′ on each bottle 20 do not immediately come into contact and are initially separated by a physical gap “G” (see FIG. 9) during this initial contact between primary bearing surfaces 30, 30′ on the bottles. Preferably, the gap G between surfaces 30, 30′ is equal to or less than maximum combined allowable deformation ε+\acute{ε} distances for reasons given herein. In one preferred embodiment, gap G may be equal to or less than about 3 mm (allowing for manufacturing tolerances).

As the forward narrow side 25 of the second bottle 20 now is further forcefully pushed or forced into the stationary or almost stationary rearward narrow side 26 of the first bottle at the filling station or elsewhere on the conveyor line, a contact force CF2 greater than CF1 (see FIGS. 10 and 11) occurs. The first and second primary contact surfaces 30, 30′ deform and bend or deflect inwards towards the axial centerlines of each respective bottle. Just prior to a maximum predetermined permissible degree of deformation ε, \acute{ε} for contact surfaces 30, 30′ respectively that is selected to coincide with approximately the stage just prior to the plastic bottles 20 being damaged (e.g. permanent plastic deformation or crazing), the third and fourth preferably larger secondary bearing surfaces 32, 32′ of the two bottles are configured and adapted to now mutually engage with a contact force CF3 therebetween and initial gap G is eliminated. This additional load bearing surface engagement creates resistance to further deformation between the primary bearing surfaces 30, 30′ sufficient to prevent or minimize damage to the bottle by creating additional active load bearing regions on the bottle. Some slight elastic bending may occur between surfaces 32 and 32′ which similarly is below the maximum permissible deformation ε and \acute{ε} amount for the material. The bending or deformation occurring at surfaces 30, 30′ thus reaches a maximum position (shown by dotted lines 31, 31′ in FIG. 11) which preferably is equal to the maximum permissible deformation ε and \acute{ε} that is selected to avoid damaging the bottle. The bottles 20 will each then elastically return to their original undeformed configurations preferably without any significant signs of crazing or other damage as the impact loads CF2 and CF3 are removed.

It will be appreciated that in some embodiments, tertiary and further bearing surfaces may be provided at other locations on narrow sides 25, 26 of bottle 20 which may further limit the deformation ε and \acute{ε} to an amount below the plastic limit of the material selected or excessive elastic bending which might leave crazing residual marks.

Although some existing flat bottle designs have adopted single contiguous large surfaces on the narrow forward and rearward sides to prevent denting or crazing, this solution imposes restrictions on the possible shapes which can be used by the bottle designer. Without having to resort to heavier bottle materials such as polyethylene, the two-stage load bearing system provided by the present invention as described herein advantageously allows the use of lighter weight flat plastic bottles like those made of PET or similar while simultaneously providing greater design flexibility than those past approaches. Preferably, a bottle 20 according to the present invention has two or more contact regions which may be vertically spaced apart on the narrow sides 25, 26 of the bottle. This allows light weight flat-type bottles as defined herein to have numerous variations in shape and contoured features in contrast to the relatively plain bottle designs of the past having sometimes restricted to nothing more than reinforcing groove or rib features incorporated into the body of the bottle.

It will be appreciated that both primary bearing surfaces 30, 30′ and secondary bearing surfaces 32, 32′ describe regions on narrow sides 25, 26 of bottle 20 having a pre-defined surface area that is selected to resist excessive deformation of the bottle and avoid damage as described herein. Preferably, primary bearing surfaces 30, 30′ have a smaller surface area than bearing surfaces 32, 32′. The external force exerted on these surfaces 30, 30′ and 32, 32′ will be dependent upon the particular speed of the bottle processing line. In addition, the resistance of the bottle to deformation under the anticipated forces or loads will be dependent on the actual wall thickness of the bottle selected and the plastic material selected. It is well within the ambit of one skilled in the art to determine the required bearing surface area for surfaces 30, 30′ and 32, 32′ that are necessary to prevent damage to the bottle induced during the processing line operations. Finally, while the secondary bearing surfaces 32, 32′ are exemplified as being located on the base 27 of the bottle 20, it is to be understood that the invention is not so limited. For example, in alternative embodiments, it may be desirable to locate the secondary bearing surfaces 32, 32′ on the shoulder portion of the bottle, or on another portion of the bottle above a vertical midpoint.

As representative examples, without limitation, light weight flat bottles according to the present invention may be produced in typical capacities preferably of between 100 ml and 10 L and used to hold any type of liquid provided a suitable chemically resistant plastic is selected. Representative weights of bottles according to the present invention may be in the 40-50 g range for 1 L with for example a container size 126 mm width, 232 mm height (without neck), and 56 mm depth; 45-55 g range for 1.25 L with for example a container size 126 mm, width 265 mm height (without neck), and 61 mm depth; and 50-65 g range for 1.5 L with for example a container size 126 mm width, 265 mm height (without neck), and 70 mm depth.

It will be understood that while the invention has been described in conjunction with specific embodiments thereof, the foregoing description and examples are intended to illustrate, but not limit the scope of the invention. Other aspects, advantages and modifications will be apparent to those skilled in the art to which the invention pertains, and these aspects and modifications are within the scope of the invention and described and claimed herein.

1. A plastic bottle comprising:
sidewalls formed of an elastically deformable plastic material and defining a central vertical axis, the sidewalls including opposing sides;
a first primary load bearing surface disposed on a first of the opposing sides and located at a first distance from the central axis; and
a first secondary load bearing surface disposed on the first of the opposing sides either above or below the primary load bearing surface and located at a second distance from the central axis that is less than the first distance;
wherein the first of the opposing sides is configured and structured to have a predetermined maximum allowable inward deflection ε towards the central axis wherein an inward deformation of the first of the opposing sides exceeding the predetermined maximum allowable deflection ε results in plastic deformation or crazing of the first of the opposing sides;
wherein the second distance is less than the first distance by an amount substantially equal to, or less than, the maximum allowable deflection ε.

2. The bottle of claim 25, wherein the bottle is made of PET.

3. The bottle of claim 2, further comprising a circumferential groove formed between the base and portions of the sidewall above the base.

4. The bottle of claim 2, wherein the wide sides define a minor axis therebetween and the narrow sides define a major axis therebetween, the bottle having a ratio of the major axis to minor axis equal to or larger than 1.5:1.

5. The bottle of claim 2, wherein the at least one narrow side has a nominal wall thickness in the range from about and including 0.15 mm to about and including 0.3 mm.

6. The bottle of claim 2, further comprising:
a second primary load bearing surface disposed on the base on the remaining narrow side opposite the first primary load bearing surface and located at a third distance from the central axis; and
a second secondary load bearing surface disposed on the base above the second primary load bearing surface, the second secondary load bearing surface located at a fourth distance from the central axis that is less than the third distance.

7. The bottle of claim 6, wherein the fourth distance is less than the third distance by an amount substantially equal to a maximum allowable deflection \acute{ε} of the second primary load bearing surface of the base, and the sum of the total maximum allowable deflection ε+\acute{ε} is about 3 mm.

8. The bottle of claim 6, wherein both the first and second primary load bearing surfaces are at the same elevation and both the first and second secondary load bearing surfaces are at the same elevation.

9. The bottle of claim 2, wherein the first primary load bearing surface is vertically spaced apart from the first secondary load bearing surface.

10. The bottle of claim 25 further comprising:
a top;
a bottom;
the sidewalls extending between the top and bottom, the two opposing wide sides being a wide front side and an opposing wide rear side defining a minor axis and depth therebetween, and the two opposing narrow sides being a narrow forward facing side and an opposing narrow rearward facing side defining a major axis and width therebetween larger than the depth;
the base being integral with the sidewalls;
the base protruding horizontally outwards beyond each of the two narrow sides in a forward and rearward direction;
the base being configured and structured to have a predetermined maximum allowable inward deflection ε towards the central axis on the forward facing narrow side and a predetermined maximum allowable inward deflection \acute{ε} towards the central axis on the rearward facing narrow side, wherein an inward deformation of the base exceeding the maximum allowable deflection ε or \acute{ε} results in plastic deformation or crazing of the base;
first primary load bearing surface being disposed on the base on the forward facing narrow side;
a first secondary load bearing surface being disposed on the forward facing narrow side and spaced vertically apart from the first primary load bearing surface on the base;
a second primary load bearing surface disposed on the base on the rearward facing narrow side and located at a third distance from the central axis; and
a second secondary load bearing surface disposed on the rearward facing narrow side and spaced vertically apart from the second primary load bearing surface on the base, the second secondary load bearing surface being located at a fourth distance from the central axis that is less than the third distance.

11. The bottle of claim 10, wherein second secondary load bearing surface is disposed on the base on the rearward facing narrow side of the bottle.

12. The bottle of claim 10, wherein the bottle is made of PET.

13. The bottle of claim 12, further comprising a circumferential groove formed between the base and portions of the sidewall above the base.

14. The bottle of claim 12, a ratio of the major axis to minor axis equal to or larger than 1.5:1.

15. The bottle of claim 12, wherein the two opposing narrow sides each has a nominal wall thickness in the range from about and including 0.15 mm to about and including 0.3 mm.

16. A method for processing plastic bottles, the method comprising:
providing a first and a second plastic bottles each of the first and second plastic bottles being as defined in claim 25, wherein, for each bottle,
the base is integral with the sidewalls one of the two opposing narrow sides is a forward facing narrow side extending between the wide sides, and the other of the two opposing rearward facing narrow side extending between the wide sides;
at least a portion of the horizontally enlarged base is configured to protrude forward beyond the forward facing narrow side of the bottle to constitute the first primary load bearing surface, and
the horizontally enlarged base comprises a rearward protruding base portion that protrudes beyond the rearward facing narrow side of the bottle to constitute a second primary load bearing surface located a third distance from the central axis and a second secondary load bearing surface disposed on the base above the second primary load bearing surface,
the second secondary load bearing surface located at a fourth distance from the central axis that is less than the third distance;
moving the first and second bottles together on a process line conveyor with respective forward facing narrow sides of the bottles facing the direction of travel and with the second bottle positioned directly behind the first bottle on the conveyor;
slowing or stopping movement of the first bottle to cause engagement of the first primary load bearing surface of the second bottle with the second primary load bearing surface of the first bottle;
forcing the forward facing narrow side of the second bottle into the stationary or almost stationary rearward facing narrow side of the first bottle to cause deflecting of the first primary load bearing surface of the second bottle inwards towards the central axis of the second bottle;
engaging the first secondary load bearing surface of the second bottle with the second secondary load bearing surface of the first bottle; and
removing the engagement of the first primary load bearing surface of the second bottle with the second primary load bearing surface of the first bottle, such that the first primary load bearing surface returns to an original configuration before the deflecting step without plastic deformation or crazing of the base.

17-23. (canceled)

24. The bottle of claim 1 wherein the sidewalls are made of PET.

25. The bottle of claim 1 further comprising:
a base formed of the elastically deformable plastic material,
wherein the sidewalls including two opposing wide sides and the two opposing sides, which two opposing sides are two opposing narrow sides;
wherein the base being horizontally enlarged in relation to the sidewalls and protruding outwards beyond at least one of the two opposing narrow sides of the bottle;
wherein the first primary load bearing surface being disposed on the base on the at least one narrow side; and
wherein the first secondary load bearing surface disposed on the at least one narrow side above the first primary load bearing surface;
wherein the base is configured and structured to have the predetermined maximum allowable inward deflection ε towards the central axis wherein an inward deformation of the base exceeding the maximum allowable deflection ε results in plastic deformation or crazing of the base.
